(19) United States
(12) Patent Application Publication
(10) Pub. No.: US 2009/0214030 A1
(43) Pub. Date: Aug. 27, 2009

(54) Apparatus and Method for Processing Fragmented Cryptographic Keys

(76) Inventor: William F. Price, III, Los Altos, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/334,242

(22) Filed: Dec. 12, 2008

Related U.S. Application Data
(60) Provisional application No. 61/013,432, filed on Dec. 13, 2007.

(51) Int. Cl. H04L 9/00

(52) U.S. Cl. 380/44; 380/279

(57) ABSTRACT

A system includes a set of private key fragments distributed across a set of networked resources. Each private key fragment independently produces a fractional cryptographic result. A combination module on a designated networked resource combines a sufficient number of fractional cryptographic results to produce an operable cryptographic result. A method includes generating a set of private key fragments. The set of private key fragments is located across a set of networked resources. Fractional cryptographic results are produced at the set of networked resources. The fractional cryptographic results are combined to produce an operable cryptographic result.

### CROSS-REFERENCE TO RELATED APPLICATIONS

This application claims priority to U.S. Provisional Patent Application 61/013,432, filed Dec. 13, 2007, entitled “Apparatus and Method for Processing Fragmented Cryptographic Keys”, the contents of which are incorporated herein by reference.

This application is also related to the concurrently filed patent application entitled “Apparatus and Method for Facilitating Cryptographic Key Management Services”, Ser. No. ______, filed Dec. 12, 2008.

### FIELD OF THE INVENTION

This invention relates generally to data security. More particularly, this invention relates to data security operations that rely upon fragmented cryptographic keys.

### BACKGROUND OF THE INVENTION

Secret sharing refers to any method of distributing a secret among a group of participants, where each participant is allocated a fraction of the secret. The secret can only be reconstructed when the shares are combined. Thus, individual shares are of no use on their own.

In a secret sharing scheme, there is one dealer and “n” players. The dealer gives a secret to the players when specific conditions are fulfilled. For example, each player is given a fractional share of the secret in such a way that any group of “t” (for threshold) or more players can together reconstruct the secret, but no group of fewer than t players can do so. Such a system is called a (t, n)-threshold scheme. Thus, securing a sufficient threshold of fractional shares allows a player to secure the entire secret. Since the secret can be revealed to any one of the n players, there is a significant risk associated with this approach. Effectively, any one of n players may end up with a private key. This significantly compromises the security associated with the private key.

In view of the foregoing, it would be desirable to develop a technique wherein a secret can be shared among a group, but the secret is never revealed to any member of the group.

### SUMMARY OF THE INVENTION

The invention includes a system with a set of private key fragments distributed across a set of networked resources. Each private key fragment independently produces a fractional cryptographic result. A combination module on a designated networked resource combines a sufficient number of fractional cryptographic results to produce an operable cryptographic result.

The invention also includes a computer readable storage medium with executable instructions to receive fractional cryptographic results from a set of private key fragments distributed across a set of networked resources. The fractional cryptographic results are combined to produce an operable cryptographic result.

The invention also includes a method of generating a set of private key fragments. The set of private key fragments is located across a set of networked resources. Fractional cryptographic results are produced at the set of networked resources. The fractional cryptographic results are combined to produce an operable cryptographic result.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations performed in accordance with an embodiment of the invention.

Like reference numerals refer to corresponding parts throughout the several views of the drawings.

### DETAILED DESCRIPTION OF THE INVENTION

The invention utilizes distributed key fragments to maintain a shared secret. However, the secret itself is never shared or otherwise revealed to any key fragment recipient. In other words, the dealer maintains the secret, but the players are never exposed to the secret.

Any key fragment by itself is meaningless, but it may have a key type that distinguishes it from other keys. A key fragment produces partial results. Given partial results from a sufficient number of key fragments, a full decryption operation can be performed. Thus, unlike the prior art that requires a full key or secret to perform cryptographic operations, the invention utilizes independent key fragments to perform a fraction of a desired cryptographic operation. When a sufficient number of cryptographic results are combined, an actual cryptographic operation may be performed. Importantly, at no time is the actual key reconstituted. Thus, the key is not susceptible to prior art security vulnerabilities.

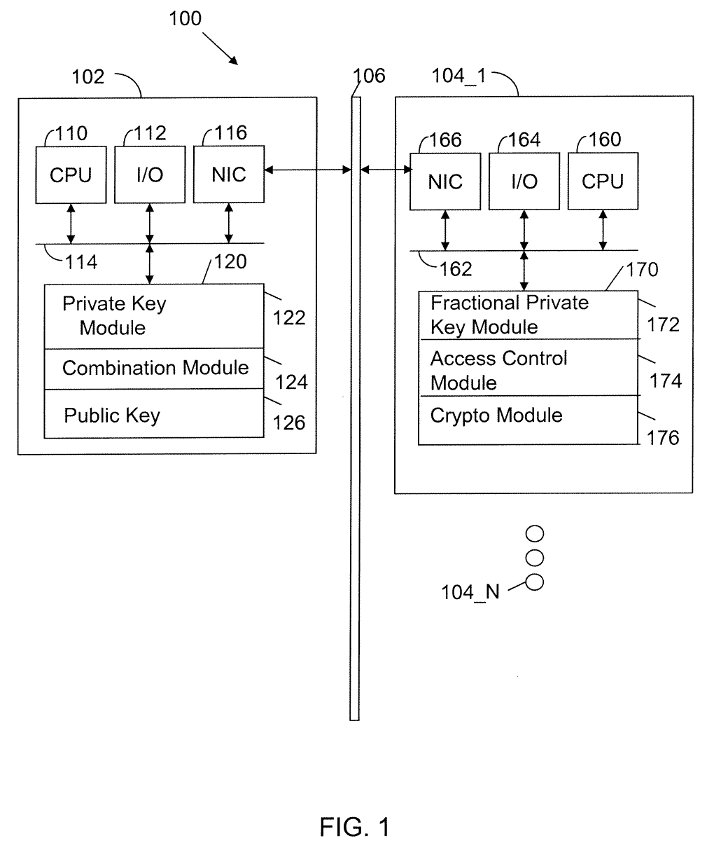

FIG. 1 illustrates a system 100 implemented in accordance with an embodiment of the invention. The system 100 includes a central networked resource 102 and a set of distributed networked resources 104_1 through 104_N (collectively 104) connected via a transmission medium 106, which may be any wired or wireless interface.

The central networked resource 102 includes standard components, such as a central processing unit 110 and input/output devices 112 linked by a bus 114. The input/output devices 112 may include standard components, such as keyboard, mouse, display, printer and the like. A network interface circuit (NIC) 116 is also connected to the bus 114 to provide connectivity to the transmission medium 106.

A memory 120 is also connected to the bus 114. The memory 120 stores executable modules to implement operations of the invention. In one embodiment, the memory 120 stores a private key module 122. The private key module 122 may include executable instructions to generate a set of private key fragments and then distribute the private key fragments to the distributed network resources 104. Alternately, the private key module 122 includes executable instructions to receive private key fragments generated by the distributed network resources 104. In either embodiment, the private key module 122 stores a complete private key in a secure manner.

The memory 120 also stores a combination module 124. The combination module 124 includes executable instructions to combine fractional cryptographic results generated by the distributed network resources 104 to produce an operable cryptographic result. The operable cryptographic result may be combined with the public key 126 to access data.

Each distributed network resource (e.g., 104_1) also includes standard components, such as a central processing unit 160 linked to a set of input/output devices 164 via a bus 162. A network interface circuit (NIC) 166 is also connected to the bus 162. Further, a memory 170 is connected to the bus 162. The memory 170 stores a fractional private key module 172. In one embodiment, the fractional private key module 172 generates a fractional private key and then conveys it to the private key module 122. In another embodiment, the fractional private key module 172 receives a fractional private key from the private key module 122. An access control module 174 includes executable instructions to provide access control to the private key fragment. For example, the access control module 172 may include executable instructions to provide password protected access to the private key fragment.

The memory 170 also stores a cryptographic module 176. In one embodiment, the cryptographic module 176 accesses the public key 126 and uses its private key fragment to produce a fractional cryptographic result, which is passed to the combination module 124. In another embodiment, the cryptographic module 176 simply passes the fractional private key to the cryptographic module 176 as a fractional cryptographic result.

The combination module 124 may be configured to yield an operable cryptographic result based upon a specified number of fractional cryptographic results. For example, consider a system with five key fragments. A threshold of three fractional cryptographic results may be specified before the combination module 124 supplies an operable cryptographic result. Observe that each distributed network resource only has a fractional key and only produces a fractional cryptographic result. Only the central networked resource 102 maintains a complete private key. Thus, only the dealer (i.e., the central networked resource) has access to the secret, while the various players (i.e., the networked resources 104) never have access to the secret (e.g., the private key).

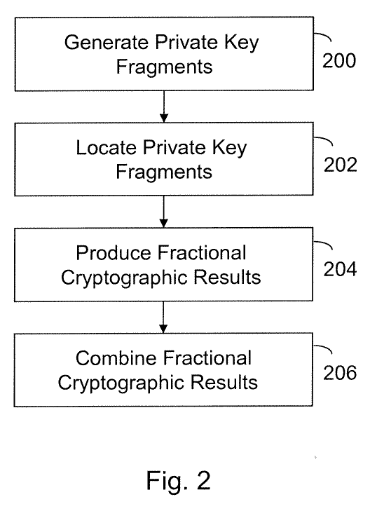

FIG. 2 illustrates processing operations associated with an embodiment of the invention. Initially, private key fragments are generated 200. Next, the private key fragments are located across networked resources 202. The private key fragments may be generated at the central network resource 102 and then be located across the distributed networked resources 104. Alternately, each private key fragment may be generated at a distributed networked resource 104 and then be conveyed to the central network resource 102. In this instance, the generating 200 and locating 202 operations are effectively combined.

Fractional cryptographic results are then produced 204. In particular, a subset of the distributed networked resources generate fractional cryptographic results. This may be implemented with the cryptographic module 176 at each distributed networked resource 104.

Finally, the factional cryptographic results are combined to produce an operable cryptographic result 206. This operation may be implemented with the combination module 124 of the central networked resource 102.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A system, comprising:
a plurality of private key fragments distributed across a plurality of networked resources, each private key fragment independently producing a fractional cryptographic result; and
a combination module on a designated networked resource to combine a sufficient number of fractional cryptographic results to produce an operable cryptographic result.

2. The system of claim 1 wherein each networked resource accesses a common public key corresponding to the plurality of private key fragments.

3. The system of claim 1 wherein each private key fragment is distributed to a different networked resource.

4. The system of claim 1 wherein each private key fragment is generated at a different networked resource.

5. The system of claim 1 wherein the complete private key corresponding to the plurality of private key fragments is never reconstituted.

6. The system of claim 1 wherein the operable cryptographic result is utilized to access data.

7. The system of claim 1 further comprising unique access controls for each private key fragment.

8. A computer readable storage medium, comprising executable instructions to;
receive fractional cryptographic results from a plurality of private key fragments distributed across a plurality of networked resources; and
combine the fractional cryptographic results to produce an operable cryptographic result.

9. The computer readable storage medium of claim 8 further comprising executable instructions to access a common public key corresponding to the plurality of private key fragments.

10. The computer readable storage medium of claim 8 further comprising executable instructions to access data utilizing the operable cryptographic result.

11. A method, comprising:
generating a plurality of private key fragments;
locating the plurality of private key fragments across a plurality of networked resources;
producing fractional cryptographic results at the plurality of networked resources;
combining the fractional cryptographic results to produce an operable cryptographic result.

12. The method of claim 11 further comprising combining the operable cryptographic result with a public key to access data.

13. The method of claim 11 wherein generating includes generating the plurality of private key fragments at the plurality of networked resources.

14. The method of claim 11 wherein generating includes generating the plurality of private key fragments at a central networked resource and then distributing the plurality of private key fragments to the plurality of networked resources.

15. The method of claim 11 further comprising protecting the plurality of private key fragments with access controls.
